(19) United States
(12) Patent Application Publication
(10) Pub. No.: US 2017/0300608 A1
(43) Pub. Date: Oct. 19, 2017

(54) METHOD, SYSTEM AND PROGRAM PRODUCT FOR SADP-FRIENDLY INTERCONNECT STRUCTURE TRACK GENERATION

(71) Applicant: GLOBALFOUNDRIES Inc., Grand Cayman (KY)

(72) Inventors: Haritez NARISETTY, Fremont, CA (US); John LEE, Saratoga, CA (US); Shitiz ARORA, Fremont, CA (US)

(73) Assignee: GLOBALFOUNDRIES Inc., Grand Cayman (KY)

(21) Appl. No.: 15/346,504

(22) Filed: Nov. 8, 2016

Related U.S. Application Data
(60) Provisional application No. 62/324,827, filed on Apr. 19, 2016.

(51) Int. Cl. G06F 17/50

(52) U.S. Cl. CPC G06F 17/5077; G06F 17/5081; G06F 2217/06

(57) ABSTRACT

A method includes providing a semiconductor interconnect implementation tool, and designing, using any one, a combination or all of the self-aligned double-patterning-friendly rule(s) described herein and in conjunction with the semiconductor interconnect implementation tool, at least two routing layers, each routing layer having routing lines, the routing lines including line(s) having a default width and line(s) having a non-default width. A system and program product corresponding to the method are also provided.

### CROSS-REFERENCE TO RELATED APPLICATIONS

This application claims priority under 35 U.S.C. §119 to U.S. Provisional Application No. 62/324,827, filed Apr. 19, 2016, which is herein incorporated by reference in its entirety.

### BACKGROUND OF THE INVENTION

### Technical Field

The present invention generally relates to self-aligned double-patterning (SADP). More particularly, the present invention relates to rules for interconnect structure track generation to reduce or eliminate errors in downstream SADP process(s).

### Background Information

SADP (also known as “Spacer Technology” or “sidewall image transfer technology”) requires highly regular layouts for each decomposition. In the past, this was accomplished via the designer(s) only using default-width routing, or non-default width route for an entire width of the design, but it may be necessary to include non-default-width routing in regions of a design along with default routing to meet various needs. However, doing so has led to decomposition issues, which are difficult to foresee. A trial and error solution is also not practical, due to potential lost time and the associated cost.

Therefore, a need exists for the reduction or elimination of SADP errors from interconnect structure track generation.

### SUMMARY OF THE INVENTION

This invention implements a set of rules that guide track generation in implementation tools to ensure the router can still perform track-based default and non-default width routing co-existing in the same design while ensuring the resulting layouts are regular enough to achieve first-time correct SADP (Self-Aligned Double Patterning) decomposition.

Having default and non-default width routes in the same layout without routing direction polygon edges aligned to be correct for SADP will require expensive track transition structures which is difficult for automatic tools to formulate.

The shortcomings of the prior art are overcome and additional advantages are provided through the provision, in one aspect, of a method of routing for semiconductor designs. The method includes providing a semiconductor interconnect implementation tool, and designing, using at least one self-aligned double-patterning-friendly rule in conjunction with the semiconductor interconnect implementation tool, at least two routing layers, each routing layer having a plurality of routing lines, the plurality of routing lines including at least one line having a default width and at least one line having a non-default width.

In another aspect, a system is provided. The system includes a semiconductor interconnect implementation tool (SIIT), the semiconductor interconnect implementation tool including a memory, and at least one processor in communication with the memory to perform a method. The method includes designing, using at least one self-aligned double-patterning-friendly rule in conjunction with the semiconductor interconnect implementation tool, at least two routing layers, each routing layer having a plurality of routing lines, the plurality of routing lines including at least one line having a default width and at least one line having a non-default width.

In yet another aspect, a computer program product is provided. The computer program product includes a physical storage medium readable by a processor and storing instructions for execution by the processor for performing a method, the method including providing a semiconductor interconnect implementation tool, and designing, using at least one self-aligned double-patterning-friendly rule in conjunction with the semiconductor interconnect implementation tool, at least two routing layers, each routing layer having a plurality of routing lines, the plurality of routing lines including at least one line having a default width and at least one line having a non-default width.

Additional features and advantages of this invention will become apparent from the following detailed description of the various aspects of the invention taken in conjunction with the accompanying drawings.

### BRIEF DESCRIPTION OF THE DRAWINGS

FIG. 1 depicts one simplified, high-level example of a semiconductor routing layer, the semiconductor routing layer including horizontal routing tracks and two polygons, covering two routing tracks, each polygon being a “net” and representing a predetermined location where routing is possible, the two routing tracks being close enough together so as to be considered overlapping, in accordance with one or more aspects of the present invention.

FIG. 2 depicts one simplified, high-level example of another semiconductor routing layer illustrating default routing tracks having a defined width (e.g., 20 nm) and non-default routing tracks having different widths (e.g., 100 nm and 40 nm, respectively), in accordance with one or more aspects of the present invention.

FIG. 3 illustrates one simplified, high-level example of a partial third routing layer including a first group of routing lines and a second group of routing lines, the first group of routing lines each being a default track width and having a default pitch (routing line-to-routing line distance) and a default width being assigned, the second group of routing lines similar to the first group, except that no width is assigned, and each of the groups assuming one of a discrete number of SADP widths, in accordance with one or more aspects of the present invention.

FIG. 4 illustrates one example of a fourth routing layer after results of a spacing check between consecutive tracks to ensure there is enough space for routes to be SADP-friendly, in accordance with one or more aspects of the present invention. The routing tracks include three different types of routing tracks, a non-default 5× (can also be 9× or 13×) default-width track, a default-width/pitch track with no width assigned, and a default-width/pitch track with a width assigned, the check marks representing SADP-friendly aspects and the “X” marks representing non-SADP-friendly aspects.

FIG. 5 illustrates one simplified, high-level example of a fifth routing layer, the fifth routing layer including routing tracks, the routing tracks including those having a default width/pitch and no assigned width, those having a default width/pitch with assigned width, those having a non-default width 150 that is/are 5×, 9× or 13× the default width and those having a non-default width, in accordance with one or more aspects of the present invention.

FIG. 6 illustrates one simplified, high-level example of a sixth routing layer, the sixth routing layer including horizontal tracks and three nets covering routing tracks, the two checked nets having widths equal to a specified non-default width of the respective track (here, simplified to a dashed line), while the with “X” has a non-default width not equal to a width of the track (compare width), in accordance with one or more aspects of the present invention.

FIG. 7 illustrates one simplified, high-level example of a seventh routing layer, the seventh routing layer including horizontal tracks covered at several locations by various sized polygons, and including 3× width virtual tracks, in accordance with one or more aspects of the present invention.

FIG. 8 depicts one example of a computer program product, in this example, a non-transitory storage medium, for example, a CD-ROM storing program code logic, in accordance with one or more aspects of the present invention.

FIG. 9 depicts one example of a data processing system suitable for storing and/or executing program code is usable that includes at least one processor couple directly or indirectly to memory elements through a system bus, in accordance with one or more aspects of the present invention.

FIG. 10 is one example of a flow diagram for the method of the present invention, the flow diagram showing two common aspects at the top with optional SADP-friendly routing rules therebelow, in accordance with one or more aspects of the present invention.

FIG. 11 depicts a high-level simplified block diagram showing one example of an interconnect implementation tool (i.e., track-based digital implementation routing tool for routing millions or billions of nets) useful to implement the present invention, the tool including a data-processing subsystem, such as that depicted in FIG. 9, programmed (e.g., using the program product shown in FIG. 8) to assist with performing the method of the present invention, in accordance with one or more aspects of the present invention.

FIG. 12 depicts a legend for the various track types found in FIGS. 1-7, in accordance with one or more aspects of the present invention.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

The terminology used herein is for the purpose of describing particular examples only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include (and any form of include, such as “includes” and “including”), and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more steps or elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable or suitable. For example, in some circumstances, an event or capacity can be expected, while in other circumstances the event or capacity cannot occur—this distinction is captured by the terms “may” and “may be.”

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage medium(s) having computer readable program code embodied thereon.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

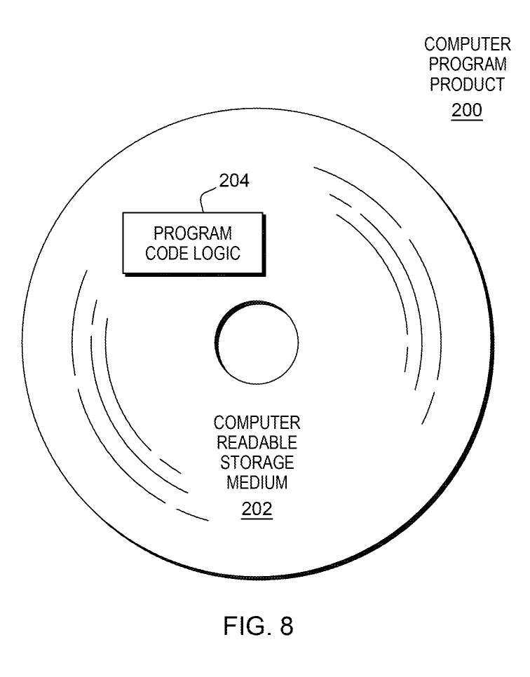

Referring now to FIG. 8, in one example, a computer program product 200 includes, for instance, one or more non-transitory computer readable storage media 202 to store computer readable program code means or logic 204 thereon to provide and facilitate one or more aspects of the present invention.

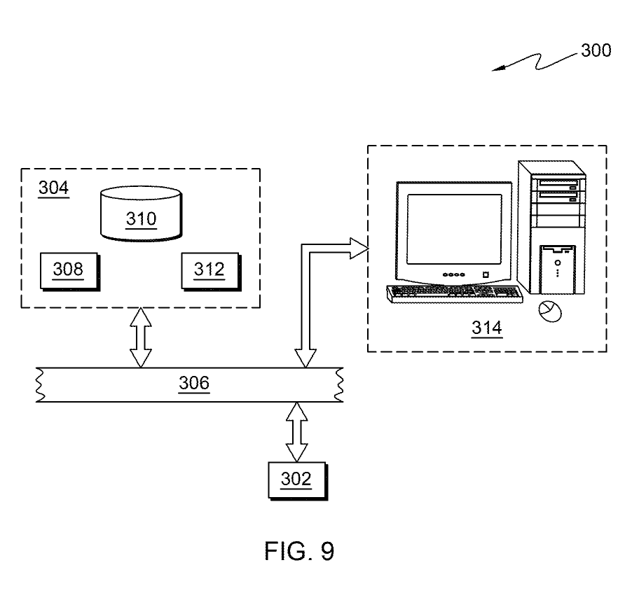

Further, a data processing system 300 (e.g., as shown in FIG. 9) suitable for storing and/or executing program code is usable that includes at least one processor 302 coupled directly or indirectly to memory elements 304 through a system bus 306. The memory elements include, for instance, local memory 308 employed during actual execution of the program code, bulk storage 310, and cache memory 312 which provides temporary storage of at least some program code in order to reduce the number of times code must be retrieved from bulk storage during execution. Other types of data processing systems may also be used, for example, a data processing system using photonics-based transistors, rather than semiconductor-based transistors.

Input/Output or I/O devices 314 (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

Program code embodied on a computer readable storage medium may be transmitted using an appropriate medium, including but not limited to, wireless, wireline, optical fiber cable, RF, etc., or any suitable combination of the foregoing.

Computer program code for carrying out operations for aspects of the present invention may be written in any combination of one or more programming languages, including an object oriented programming language, such as JAVA, Smalltalk, C++ or the like, and conventional procedural programming languages, such as the “C” programming language, assembler or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to one or more embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Further, other types of computing environments can benefit from one or more aspects. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

As used herein, “SADP-friendly” refers to all, a single or combination of the rule(s) set forth herein.

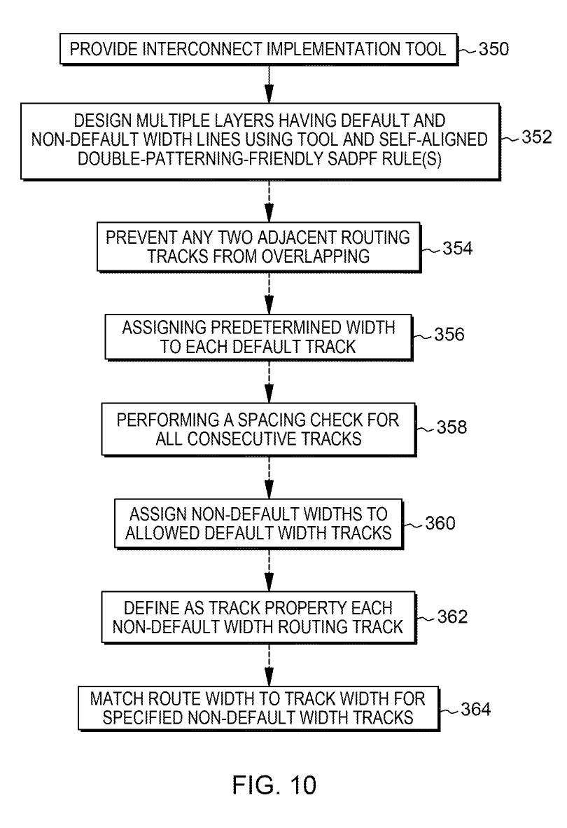

The data processing system of FIG. 9 programmed to implement the method herein may be used as part of, or in conjunction with, an interconnect implementation tool (IIT), such as that shown and described with regard to FIG. 10. Part of the value added by the present invention is that it can be used, not only going forward on shrinking nodes, but with existing IIT's and tool algorithms.

Due to limitations of currently available 193 nm wave-length lithography tools, semiconductor manufacturing process are making use of a technique called double patterning to split a single layer of conducting polygons into two mask layers, where each mask is printed using the 193 nm wave-length techniques. Two mask layers when printed will represent the whole layer of conducting polygons in totality.

In a SADP process MNDRL (Mandrel) is the first mask/deposition representing the first set of conducting polygons. There is no second mask to represent the second set of conducting polygons called NONMNDRL (Non-Mandrel). Instead, the wall of the conducting polygons from the first mask are hardened (spacer) to etch away the dielectric between these spacer walls. The conducting material deposited in this etched-away region automatically represents the second set of conducting polygons, hence, being called “Self-Aligned Double Patterning.”

The location, length and width of the MNDRL polygons is predictive as it is the first masking step. However, the NONMNDRL manifests as the inverse of the MNDRL, and its location, length and width are not predictive unless bounded by the multiple MNDRL polygons.

This limitation of NONMNDRL forms an important requirement to enforce design rules such that designer does not have to worry about what polygons are put on MNDRL versus NONMNDRL. Such a designer's requirement will require symmetry in design rules between MNDRL and NONMNDRL polygons. The symmetry in design rules between MNDRL polygons and NONMNDRL polygons can be achieved only when certain predictive routing/layout patterns are allowed.

To further bring the polygons closer at more advanced technologies like 14, 10 and 7 nm, an additional mask shape called MNDRL CUT/NONMNDRL CUT are introduced. Without such CUT mask shapes, two MNDRL polygons cannot come closer than 64 nm. Instead, a CUT mask shape allows a continuous line of MNDRL to be printed first and then just cuts the MNDRL where the designer intends to separate two different nets/polygons. Such an approach also helps to stop the leak of NONMNDRL from one side of the MNDRL to the other side of the MNDRL through the gaps between the MNDRL polygons, thereby preventing shorts between two different nets/polygons formed on NONMNDRL.

Depending on the need for further bringing the overall polygons closer, there can be separate CUT masks for MNDRL and NONMNDRL or just a one-CUT mask may be used. A similar concept may also be applied for “Self-Aligned Quadruple Patterning.”

The design would like to treat MNDRL and NONMNDRL rules with symmetry, i.e., whatever could be drawn on MNDRL should also be eligible to be drawn on NONMNDRL.

Imagine Input is the design intent and Output is what SADP will need in terms of decomposition or what ends up on silicon. The significant difference between design intent and decomposition invite differences in parasitic (resistance and capacitance) between the nets.

The present invention provides track implementation rules that help make for “SADP-friendly” routing. Each rule can stand alone or fewer than all can be combined, improving the design, but combining them all is preferred to achieve a highest degree of being SADP-friendly. First, two tracks should not overlap exactly. Second, non-default width tracks should have width defined as track property. Third, default tracks with or without width defined should assume one of the discrete widths for routes over it. Fourth, perform a spacing check between the consecutive tracks to ensure there is enough space for routes to be SADP friendly. Fifth, assign allowed widths for specific default tracks when discrete non-default widths can be allowed. Sixth, create virtual 3× width tracks exactly between the pairs of 1× width tracks when the next 2 tracks on both sides of the subject 1× width tracks are also 1× width tracks. Seventh, routes on a track with non-default width specified, should follow the width of the track. A 3× width route should have >=5× space to same color routes in one direction perpendicular to the tracks while other direction should have >=3× space to same color routes, this allows multiple 3× width routes to be done next to each other, a likely scenario for BUS routing.

Finally, stream-out the tracks to form MNDRL and NONMNDRL of SADP layer.

An alternate way of generating MNDRL and NONMNDRL shapes using the colored routed shapes

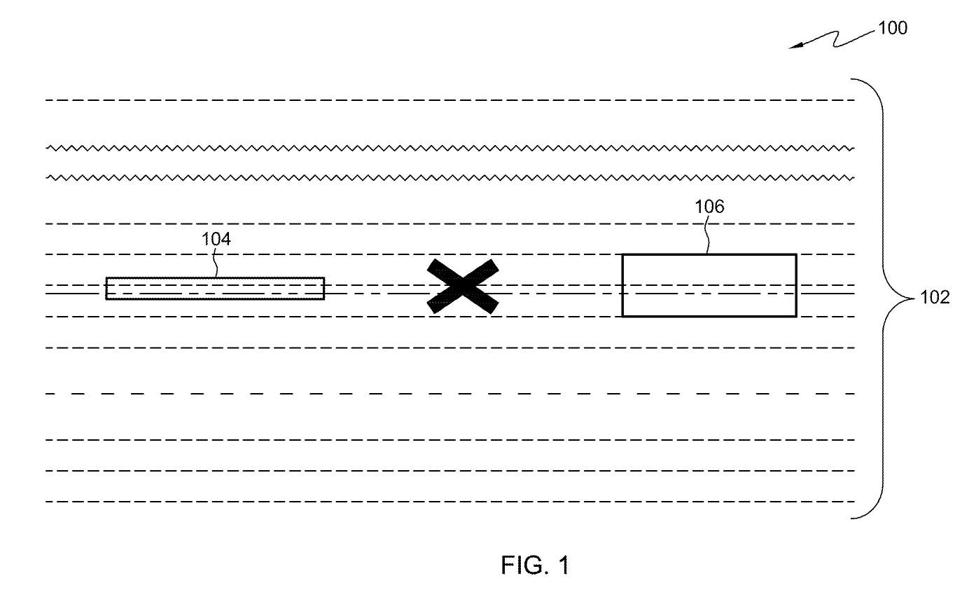

FIG. 1 depicts one simplified, high-level example of a semiconductor routing layer 100, produced, for example, employing an IIT (e.g., such as that in FIG. 10) programmed to perform the method of the present invention, the semiconductor routing layer including horizontal routing tracks 102 and two polygons 104 and 106, covering routing tracks 108 and 110, respectively, each polygon being a “net” and representing a predetermined location where routing is possible. A routing track is a zero-width line on which routes with a certain width can be drawn whose centerline aligns with the track. Returning to FIG. 1, the two routing tracks being close enough together in the diagram represents two actual tracks that are overlapping with zero spacing between the tracks, in accordance with one or more aspects of the present invention. As one skilled in the art will understand, there would also be similar vertical routing layers (i.e., rotated 90 degrees compared to the horizontal routing layers) with vertical routing layers interleaved with the horizontal routing layers. Thus, the vertical routing layers/tracks are omitted for redundancy.

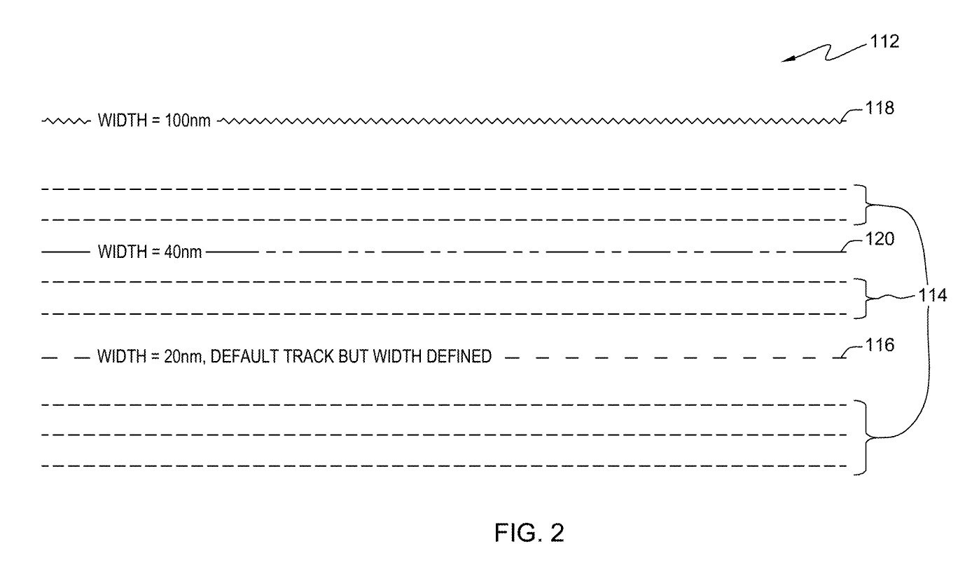

FIG. 2 depicts one simplified, high-level example of another semiconductor routing layer 112 illustrating default routing tracks 114 and 116 having a defined width (e.g., 20 nm) and non-default routing tracks 118 and 120 having different widths (e.g., 100 nm and 40 nm, respectively), in accordance with one or more aspects of the present invention.

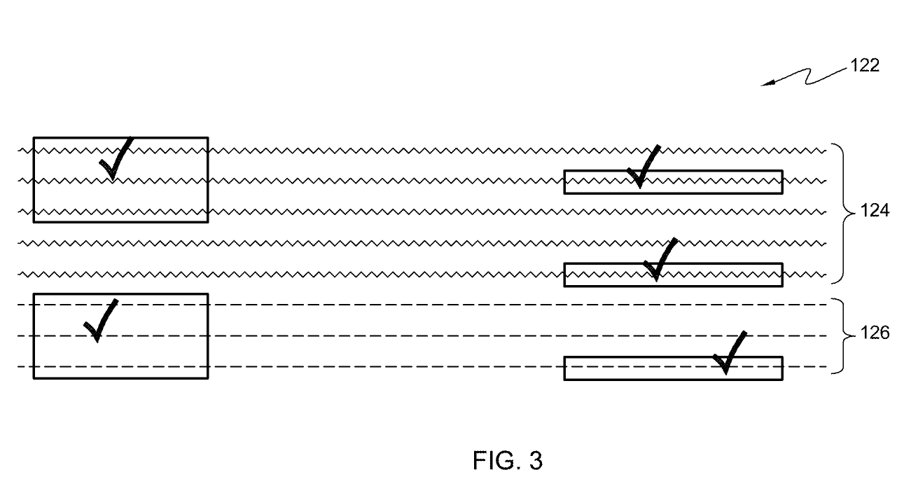

FIG. 3 illustrates one simplified, high-level example of a partial third routing layer 122 including a first group of routing lines 124 and a second group of routing lines 126, the first group of routing lines each being a default-width track and having a default pitch (routing line-to-routing line distance) and a default width being assigned, the second group of routing lines similar to the first group, except that no width is assigned, and each of the groups assuming one of a discrete number of SADP widths, in accordance with one or more aspects of the present invention.

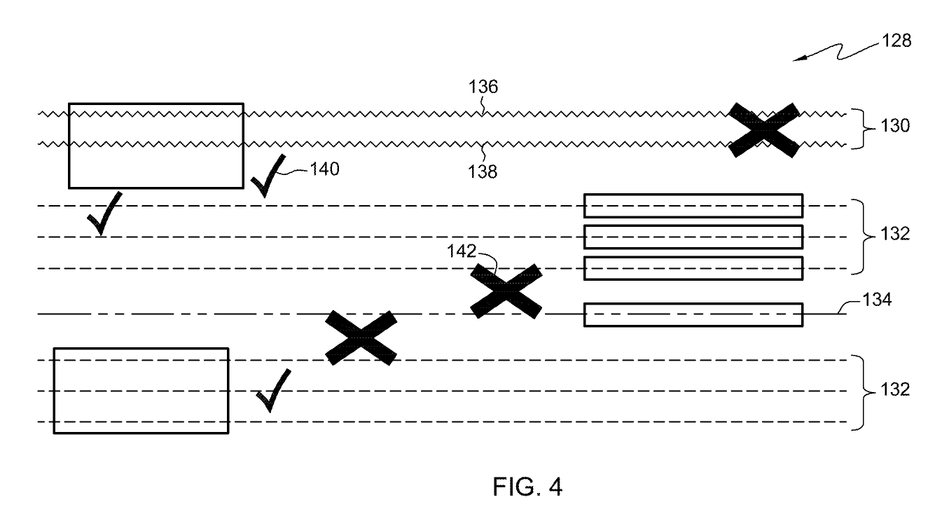

FIG. 4 illustrates one example of a fourth routing layer 128 after results of a spacing check between consecutive tracks (e.g., consecutive tracks 130 and 132) to ensure there is enough space for routes to be SADP-friendly, in accordance with one or more aspects of the present invention. The routing tracks include three different types of routing tracks: a non-default 5× (can also be 9× or 13×) default-width track 130; a default-width/pitch track with no width assigned 132; and a default-width/pitch track with a width assigned 134, the check marks 140 representing SADP-friendly aspects and the “X” marks 142 representing non-SADP-friendly aspects.

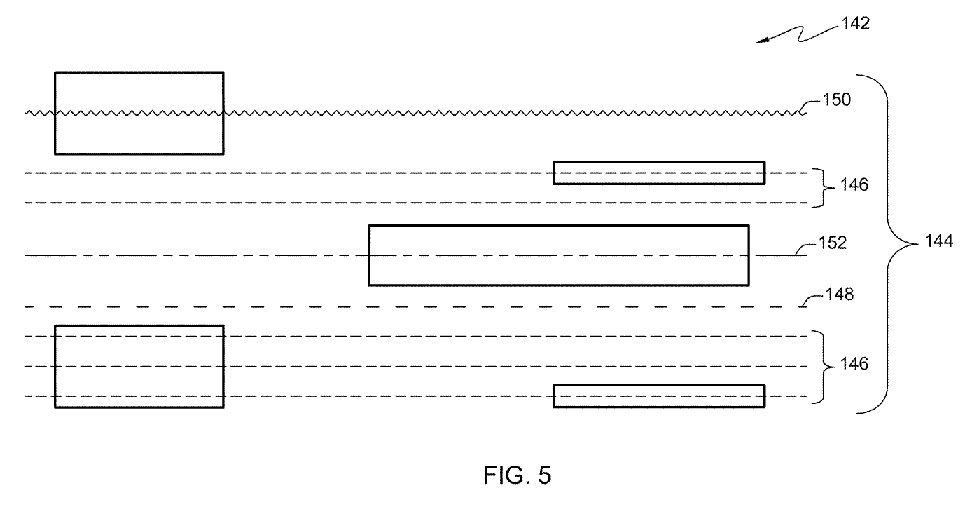

FIG. 5 illustrates one simplified, high-level example of a fifth routing layer 142, the fifth routing layer including routing tracks 144, the routing tracks including those having a default width/pitch and no assigned width 146, those having a default width/pitch with assigned width 148, those having a non-default width 150 that is/are 5×, 9× or 13× the default width and those having a non-default width 152, in accordance with one or more aspects of the present invention.

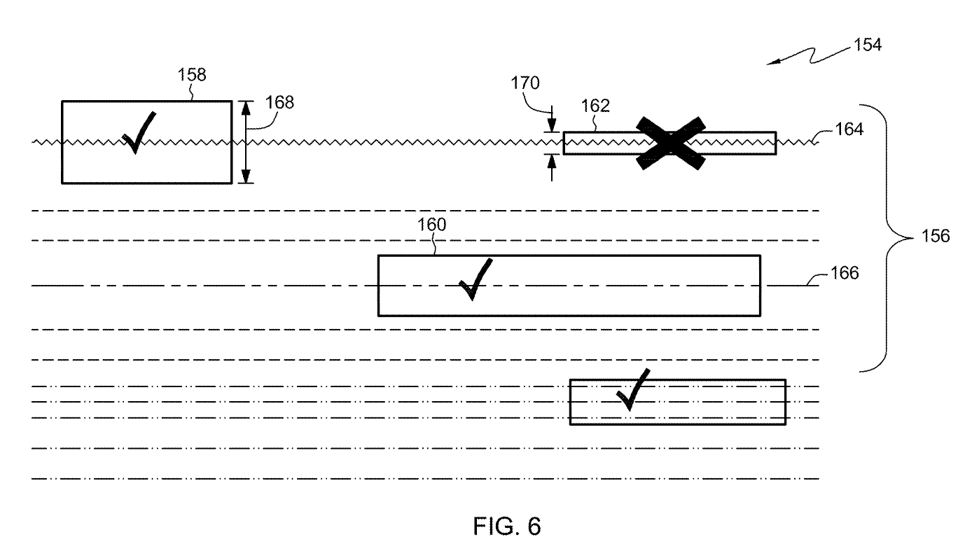

FIG. 6 illustrates one simplified, high-level example of a sixth routing layer 154, the sixth routing layer including horizontal tracks 156 and three polygons 158, 160 and 162, covering routing tracks 164 and 166, polygons 158 and 160 having a width 168 equal to a specified non-default width of the track (here, simplified to a dashed line), while polygon 162 has a non-default width 170 not equal to a width of the track (compare width 170 to 168), in accordance with one or more aspects of the present invention.

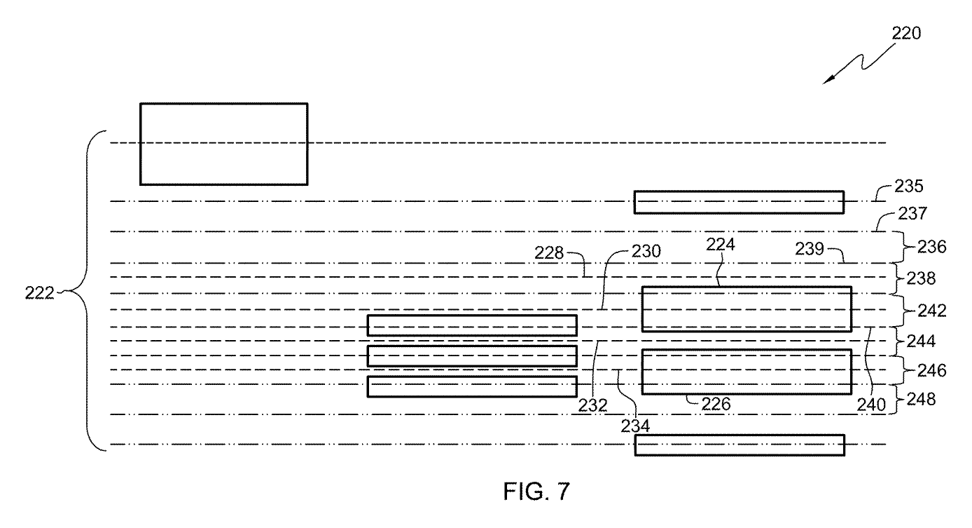

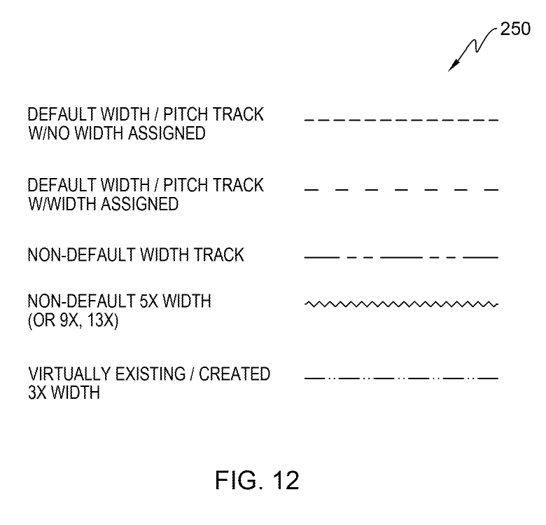

FIG. 7 illustrates one simplified, high-level example of a seventh routing layer 220, the seventh routing layer including horizontal tracks 222 covered at several locations by various sized polygons (e.g., polygons 224 and 226), and including 3× width virtual tracks 228, 230, 232 and 234, in accordance with one or more aspects of the present invention. See the legend in FIG. 12 for the various track types. In this example, virtual 3× width tracks are formed exactly between a pair of adjacent 1× width tracks if the next adjacent tracks above and below the pair are also 1× width tracks (the rule). The virtual 3× width tracks are formed in the following manner. Working downward through each pair of 1× lines satisfying the rule. The first pair, including tracks 235 and 237 cannot support a 3× width virtual track, since there is no 1× width track above track 235. The next pair 236 cannot support a virtual track, since it would overlap with the following pair 238, which satisfies the rule, since there is another 1× width track above 239 and below 240 the pair. The next three pairs, 242, 244 and 246 similarly satisfy the rule. However, pair 248 cannot satisfy the rule, since its rectangle (including the pair and vertical track therebetween) would overlap with the rectangle for pair 246 above.

FIG. 8 depicts one example of a computer program product, in this example, a non-transitory storage medium, for example, a CD-ROM storing program code logic, in accordance with one or more aspects of the present invention.

FIG. 9 depicts one example of a data processing system 300 suitable for storing and/or executing program code for implementing the method of the present invention is usable that includes at least one processor 302, coupled directly or indirectly to memory elements 304 through a system bus 306, communication with the system being done via, for example, one or more peripherals 314 or other input/output types, in accordance with one or more aspects of the present invention.

FIG. 10 is one example of a flow diagram 349 for the method of the present invention, the flow diagram showing two common aspects 350 and 352 at the top with optional SADP-friendly routing rules 354-364 (preferably using all the rules herein, or any combination thereof) therebelow, in accordance with one or more aspects of the present invention.

All the steps mentioned can be programed into a mathematical model and executed using a processor. For example, a spacing check can be done by making sure no two tracks have same y-coordinate in case of horizontal tracks. Non-compliant tracks without a non-default width assigned will show up as track spacing errors. It is a mathematical assumption where tracks that do not have a width assigned will be treated as having a default minimum width of a layer. Any wrong assumptions will be caught as track spacing errors. Assumed and assigned widths of tracks can be accessed while traversing one track at time from either the top or bottom of the block. These widths can then be used to perform the spacing check.

SpaceN==TrackN width/2+TrackN+1 width/2+SADP space

SpaceN−1==TrackN width/2+TrackN−7_width/2+SADP space

SADP space is the fixed allowed space between two polygons of a SADP layer, as determined by the process technology.

Using a mathematical model, specific tracks can be assigned to take more than one discrete width by counting the number of adjacent default-width tracks. TrackN can take the default width and 5-times the default width if TrackN−1 and TrackN+1 are default-width tracks.

Using a mathematical model, specific 3× width virtual tracks can be created between the 1× width tracks by calculating the mid-point of the two 1× width tracks:

TrackN+3=1× width

TrackN+2=1× width

TrackN+1=1× width

TrackN=Virtually created 3× width track. (TrackN is mid point of TrackN−1 and TrackN+1)

TrackN−1=1× width

TrackN−2=1× width

TrackN−3=1× width

Using a mathematical model, the non-default width routes can be restricted to tracks with non-default width assigned.

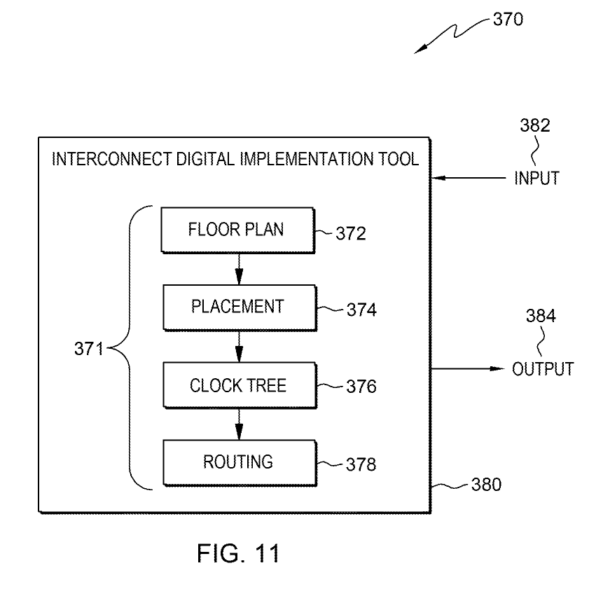

FIG. 11 depicts a high-level simplified block diagram showing one example of an interconnect implementation tool 370 (i.e., track-based digital implementation routing tool for routing millions or billions of nets) useful to implement the present invention, the tool including a data-processing subsystem, such as that depicted in FIG. 9, programmed (e.g., using the program product shown in FIG. 8) to assist with performing the method of the present invention, in accordance with one or more aspects of the present invention.

The interconnect implementation tool 370 of FIG. 11 includes a housing 380 and a computer system 371 having aspects of the programmed method, including a floor plan module 372, a placement module 374, a clock tree module 376 and a routing module 378. Inputs 382 to the tool include a net list, design constraints and other constraints. The output 384 from the tool includes a net list, a geometric data stream (e.g., GDSII) and other outputs.

FIG. 12 depicts a legend 250 for the various track types found in FIGS. 1-7.

In a first aspect, as shown in FIG. 10, disclosed above is a method. The method includes providing a semiconductor interconnect implementation tool (350, FIG. 10), and designing, using self-aligned double-patterning-friendly rule(s) in conjunction with the semiconductor interconnect implementation tool, at least two routing layers, each routing layer having routing lines, the routing lines including line(s) having a default width and line(s) having a non-default width (352, FIG. 10).

In one example, as shown in the flow diagram of FIG. 10, the self-aligned double-patterning-friendly rule(s) may include, for example, preventing, for at least one of the at least two routing layers, any two adjacent routing tracks of the routing tracks from overlapping (354, FIG. 10), and assigning to each default track one of a group of predetermined widths (356, FIG. 10). Note that the dashed lines mean that each of the aspects 354-364 can stand alone, or be used in conjunction with one or more (or all) of the other aspects 354-364.

In one example, as shown in FIG. 10, the self-aligned double-patterning-friendly rule(s) of the first aspect may include, for example, performing a spacing check for all consecutive tracks (358, FIG. 10). The check ensures that the resultant route will either have shapes such that adjacent shapes will be spaced exactly SADP distance apart, or be spaced in such a way that other default-width routing shapes could be inserted in between, resulting in all adjoining shapes having exactly SADP distance apart.

SADP distance is a technology-dependent spacing between shapes in the routing layer. All shapes in the routing layer must be spaced exactly SADP distance apart (side to side spacing) to other adjoining shapes.

In one example, as shown in FIG. 5, the self-aligned double-patterning-friendly rule(s) of the first aspect may include, for example, for each default-width track for which non-default widths can be allowed, assigning default width(s) thereto. Depending on an adjacent track configuration, the widths allowed should be limited to a sub-set which is SADP friendly. For example, for the three lowest tracks (assumed to be default tracks with no annotation of width property), the top most of the three tracks should only be assigned 5× width (overlapping three tracks) due to the non-default width tracks two tracks away. The middle of the two tracks could be assigned 5× width (covering three consecutive default-width tracks) and 9× width (covering five consecutive default-width tracks).

In one example, as shown in FIG. 10, the self-aligned double-patterning-friendly rule(s) of the first aspect may include, for example, for each default-width track for which a non-default width can be allowed, automatically assigning (via the EDA tool) a non-default width that is SADP friendly as described herein, just prior to the detailed description of FIG. 1.

In one example, as shown in FIG. 3, the self-aligned double-patterning-friendly rule(s) of the method of the first aspect may include, for example, for a region with only default tracks with no user assigned width properties, permitting only non-default widths which will overlap the center track and one or more tracks on either side, with the number of tracks to be overlapped on one side of the center track exactly equal to the number of tracks to be overlapped on the other side of the center track. So, for example, a given non-default track without a user-assigned width and multiple other default-width tracks on either side may be routed with 5× width (covering center track and one track on either side of the center track) or 9× width (covering center track and two tracks on either side of the center track) and so on. The only exception to this rule is the 3× width routing using virtually generated track as set forth above. In that case, multiple 3× width routes must be laid out adjoining each other, forming a group such that the outer-most tracks of the group overlapping the first and last 3× width routes must be of the same type as the adjacent 3× width route.

In one example, as shown in FIG. 10, the self-aligned double-patterning-friendly rule(s) of the first aspect may include, for example, defining width as a track property to each non-default-width routing track (362, FIG. 10).

In one example, as shown in FIG. 10, the self-aligned double-patterning-friendly rule(s) of the first aspect may include, for example, for routes on a given track with a non-default width specified, each route with routing width matching a width property of the given track (364, FIG. 10).

In one example, the self-aligned double-patterning-friendly rule(s) of the first aspect may include, for example, forming a virtual track of 3× default width/pitch track between a pair of adjacent default-width tracks if next adjacent tracks above and below the pair of adjacent default-width tracks are default-width tracks.

In one example, the self-aligned double-patterning-friendly rule(s) of the first aspect may include any combination (some or all) of the rules herein, for example, preventing, for at least one of the at least two routing layers, any two adjacent routing tracks of the routing tracks from overlapping, and assigning one of predetermined widths to each default track. The combination of rules may further include, for example: performing a spacing check for all consecutive tracks; for each default-width track for which a non-default width is allowed, assigning non-default width(s) thereto; defining width as a track property for each non-default width routing track; for routes on a given track with a non-default width specified, each route matching a width of the given track; and/or forming a virtual track of 3× default width/pitch track between a pair of adjacent default-width tracks if next adjacent tracks above and below the pair of adjacent default-width tracks are default-width tracks.

In a second aspect, disclosed above is a system. The system includes a semiconductor interconnect implementation tool (SIIT), the SIIT including a memory, and processor(s) in communication with the memory to perform a method, the method including designing, using self-aligned double-patterning-friendly rule(s) in conjunction with the SIIT, at least two routing layers, each routing layer having routing lines, the routing lines including line(s) having a default width and line(s) having a non-default width.

In one example, the method of the system of the second aspect may include, for example, preventing, for the routing layer(s), any two adjacent routing tracks of the routing tracks from overlapping.

In one example, the method of the system of the second aspect may include, for example, performing a spacing check for all consecutive tracks.

In one example, the method of the system of the second aspect may include, for example, for each default-width track for which a non-default width can be allowed, assigning one or more non-default width(s) thereto.

In one example, the method of the system of the second aspect may include, for example, defining width as a track property for each non-default-width routing track.

In one example, the method of the system of the second aspect may include, for example, for routes on a given track with a non-default width specified, each route matching a width of a track.

In one example, the method of the system of the second aspect may include, for example, assigning one predetermined width from a group of widths to each default.

In one example, the self-aligned double-patterning-friendly rule(s) of the second aspect may include, for example, forming a virtual track of 3× default width/pitch track between a pair of adjacent default-width tracks if next adjacent tracks above and below the pair of adjacent default-width tracks are default-width tracks.

In one example, the self-aligned double-patterning-friendly rule(s) of the second aspect may include any combination (some or all) of the rules herein, for example: preventing, for at least one of the at least two routing layers, any two adjacent routing tracks of the routing tracks from overlapping, and assigning one of predetermined widths to each default track; performing a spacing check for all consecutive tracks; for each default-width track for which a non-default width is allowed, assigning non-default width(s) thereto; defining width as a track property for each non-default width routing track; for routes on a given track with a non-default width specified, each route matching a width of the given track; and/or forming a virtual track of 3× default width/pitch track between a pair of adjacent default-width tracks if next adjacent tracks above and below the pair of adjacent default-width tracks are default-width tracks.

In a third aspect, disclosed above is computer program product. The computer program product includes a physical storage medium readable by a processor and storing instructions for execution by the processor for performing a method, the method including providing a semiconductor interconnect implementation tool, and designing, using self-aligned double-patterning-friendly rule(s) in conjunction with the semiconductor interconnect implementation tool, at least two routing layers, each routing layer having routing lines, the routing lines including line(s) having a default width and line(s) having a non-default width.

In one example, the self-aligned double-patterning-friendly rule(s) of the computer program product of the third aspect may include, for example, preventing, for each routing layer, any two adjacent routing tracks of the routing tracks from overlapping.

In one example, the self-aligned double-patterning-friendly rule(s) of the computer program product of the third aspect may include, for example, performing a spacing check for all consecutive tracks.

In one example, the self-aligned double-patterning-friendly rule(s) of the computer program product of the third aspect may include, for example, for each default-width track for which a non-default width can be allowed, assigning one or more non-default width(s) thereto, subject to previously described limitations.

In one example, the self-aligned double-patterning-friendly rule(s) of the computer program product of the third aspect may include, for example, defining width as a track property for each non-default-width routing track.

In one example, the self-aligned double-patterning-friendly rule(s) of the computer program product of the third aspect may include, for example, for routes on a given track with a non-default width specified, each route matching a width of the given track.

In one example, the self-aligned double-patterning-friendly rule(s) of the computer program product of the third aspect may include, for example, assigning one of predetermined widths to each default track.

In one example, the self-aligned double-patterning-friendly rule(s) of the third aspect may include, for example, forming a virtual track of 3× default width/pitch track between a pair of adjacent default-width tracks if next adjacent tracks above and below the pair of adjacent default-width tracks are default-width tracks.

In one example, the self-aligned double-patterning-friendly rule(s) of the third aspect may include any combination (some or all) of the rules herein, for example: preventing, for at least one of the at least two routing layers, any two adjacent routing tracks of the routing tracks from overlapping; assigning one of predetermined widths to each default track; performing a spacing check for all consecutive tracks; for each default-width track for which a non-default width is allowed, assigning non-default width(s) thereto; defining width as a track property for each non-default width routing track; for routes on a given track with a non-default width specified, each route matching a width of the given track; and/or forming a virtual track of 3× default width/pitch track between a pair of adjacent default-width tracks if next adjacent tracks above and below the pair of adjacent default-width tracks are default-width tracks.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A method, comprising:
providing a semiconductor interconnect implementation tool; and
designing, using at least one self-aligned double-patterning-friendly rule in conjunction with the semiconductor interconnect implementation tool, at least two routing layers, each routing layer having a plurality of routing lines, the plurality of routing lines including at least one line having a default width and at least one line having a non-default width.

2. The method of claim 1, wherein the at least one self-aligned double-patterning-friendly rule comprises:
preventing, for at least one of the at least two routing layers, any two adjacent routing tracks of the plurality of routing tracks from overlapping; and
assigning one of a plurality of predetermined widths to each default track.

3. The method of claim 1, wherein the at least one self-aligned double-patterning-friendly rule comprises performing a spacing check for all consecutive tracks.

4. The method of claim 1, wherein the at least one self-aligned double-patterning-friendly rule comprises, for each default-width track for which a non-default width is allowed, assigning one or more non-default width thereto.

5. The method of claim 1, wherein the at least one self-aligned double-patterning-friendly rule comprises defining width as a track property for each non-default width routing track.

6. The method of claim 1, wherein the at least one self-aligned double-patterning-friendly rule comprises, for routes on a given track with a non-default width specified, each route matching a width of the given track.

7. The method of claim 1, wherein the at least one self-aligned double-patterning-friendly rule comprises forming a virtual track of 3× default width/pitch track between a pair of adjacent default-width tracks if next adjacent tracks above and below the pair of adjacent default-width tracks are default-width tracks.

8. The method of claim 1, wherein the at least one self-aligned double-patterning-friendly rule comprises:
preventing, for at least one of the at least two routing layers, any two adjacent routing tracks of the plurality of routing tracks from overlapping and assigning one of a plurality of predetermined widths to each default track;
performing a spacing check for all consecutive tracks;
for each default-width track for which a non-default width is allowed, assigning one or more non-default width thereto;
defining width as a track property for each non-default width routing track;
for routes on a given track with a non-default width specified, each route matching a width of the given track; and
forming a virtual track of 3× a default width/pitch track between a pair of adjacent default-width tracks if next adjacent tracks above and below the pair of adjacent default-width tracks are default-width tracks.

9. A system, comprising:
a semiconductor interconnect implementation tool (SIIT), the semiconductor interconnect implementation tool comprising:
a memory; and
at least one processor in communication with the memory to perform a method, the method comprising:
designing, using at least one self-aligned double-patterning-friendly rule in conjunction with the semiconductor interconnect implementation tool, at least two routing layers, each routing layer having a plurality of routing lines, the plurality of routing lines including at least one line having a default width and at least one line having a non-default width.

10. The system of claim 9, the method further comprising preventing, for at least one of the at least two routing layers, any two adjacent routing tracks of the plurality of routing tracks from overlapping.

11. The system of claim 9, the method further comprising performing a spacing check for all consecutive tracks.

12. The system of claim 9, the method further comprising for each default-width track for which a non-default width can be allowed, assigning one or more non-default width thereto.

13. The system of claim 9, the method further comprising defining width as a track property for each non-default-width routing track.

14. The system of claim 9, the method further comprising, for routes on a given track with a non-default width specified, each route matching a width of a track.

15. The system of claim 9, the method further comprising assigning one of a plurality of predetermined widths to each default track.

16. The system of claim 9, wherein the at least one self-aligned double-patterning-friendly rule comprises forming a virtual track of 3× default width/pitch track between a pair of adjacent default-width tracks if next adjacent tracks above and below the pair of adjacent default-width tracks are default-width tracks.

17. The system of claim 9, wherein the at least one self-aligned double-patterning-friendly rule comprises:
preventing, for at least one of the at least two routing layers, any two adjacent routing tracks of the plurality of routing tracks from overlapping, and assigning one of a plurality of predetermined widths to each default track;
performing a spacing check for all consecutive tracks;
for each default-width track for which a non-default width is allowed, assigning one or more non-default width thereto;
defining width as a track property for each non-default width routing track;
for routes on a given track with a non-default width specified, each route matching a width of the given track; and
forming a virtual track of 3× a default width/pitch track between a pair of adjacent default-width tracks if next adjacent tracks above and below the pair of adjacent default-width tracks are default-width tracks.

18. A computer program product, comprising:
a non-transitory storage medium readable by a processor and storing instructions for execution by the processor for performing a method, the method comprising:
providing a semiconductor interconnect implementation tool; and
designing, using at least one self-aligned double-patterning-friendly rule in conjunction with the semiconductor interconnect implementation tool, at least two routing layers, each routing layer having a plurality of routing lines, the plurality of routing lines comprising at least one line having a default width and at least one line having a non-default width.

19. The computer program product of claim 18, wherein the at least one self-aligned double-patterning-friendly rule comprises preventing, for at least one of the at least two routing layers, any two adjacent routing tracks of the plurality of routing tracks from overlapping.

20. The computer program product of claim 18, wherein the at least one self-aligned double-patterning-friendly rule further comprises performing a spacing check for all consecutive tracks.

21. The computer program product of claim 18, wherein the at least one self-aligned double-patterning-friendly rule further comprises for each default-width track for which a non-default width can be allowed, assigning one or more allowed width(s) thereto.

22. The computer program product of claim 18, wherein the at least one self-aligned double-patterning-friendly rule comprises defining width as a track property for each non-default-width routing track.

23. The computer program product of claim 18, wherein the at least one self-aligned double-patterning-friendly rule further comprises:
for routes on a given track with a non-default width specified, each route matching a width of the track.

24. The computer program product of claim 18, wherein the at least one self-aligned double-patterning-friendly rule further comprises assigning one of a plurality of predetermined widths to each default track.

25. The computer program product of claim 18, wherein the at least one self-aligned double-patterning-friendly rule comprises forming a virtual track of 3× default width/pitch track between a pair of adjacent default-width tracks if next adjacent tracks above and below the pair of adjacent default-width tracks are default-width tracks.

26. The computer program product of claim 18, wherein the at least one self-aligned double-patterning-friendly rule comprises:
preventing, for at least one of the at least two routing layers, any two adjacent routing tracks of the plurality of routing tracks from overlapping, and assigning one of a plurality of predetermined widths to each default track;
performing a spacing check for all consecutive tracks;
for each default-width track for which a non-default width is allowed, assigning one or more non-default width thereto;
defining width as a track property for each non-default width routing track;
for routes on a given track with a non-default width specified, each route matching a width of the given track; and
forming a virtual track of 3× a default width/pitch track between a pair of adjacent default-width tracks if next adjacent tracks above and below the pair of adjacent default-width tracks are default-width tracks.
